(19) United States
(12) Patent Application Publication
(10) Pub. No.: US 2005/0126566 A1
(43) Pub. Date: Jun. 16, 2005

(54) Adaptor for use with drinking tube on protective mask

(76) Inventor: Gary R. Stone, Round Rock, TX (US)

Correspondence Address: DUANE, MORRIS, LLP, 3200 SOUTHWEST FREEWAY, SUITE 3150, HOUSTON, TX, 77027, US

(21) Appl. No.: 10/949,586

(22) Filed: Sep. 24, 2004

Related U.S. Application Data
(60) Provisional application No. 60/506,444, filed on Sep. 26, 2003.

(51) Int. Cl. A62B 17/04; A62B 18/00

(52) U.S. Cl. 128/202.15; 128/201.22

(57) ABSTRACT

An apparatus and method is provided for enabling the wearer of a protective mask to utilize the tubing of a gas mask to drink liquids from standard commercial beverage containers without removing the mask or breaking the seal between the mask and the wearer's face. An adaptor is provided that connects the drinking tubing of the protective mask with the opening of the commercially available beverage container. In one embodiment, the adaptor has a stem at one end that can be inserting into the tubing of the protective mask to deliver liquid to the wearer. In another embodiment, the adaptor is secured to the beverage container by threading. In another embodiment, the adaptor is constructed of a material that is resistant to chemical or biological agents. In another embodiment, the adaptor has a plurality of different sized sections so that the adaptor may be used on various sizes of beverage containers.

### PRIORITY INFORMATION

This application claims the benefit of U.S. Provisional Application No. 60/506,444 filed on Sep. 26, 2003.

### FIELD OF THE INVENTION

The field of the invention relates to protective masks, and more specifically, to an adaptor for connecting the drinking tube of a protective mask to a commercially available water bottle.

### BACKGROUND OF THE INVENTION

In recent years, the general public has grown increasingly aware of the potential dangers presented by terrorist activity. As a result, the demand has grown for various types of personal protective gear One example of such gear is the protective gas mask that prevents a wearer from breathing potentially harmful chemical and biological airborne agents. Previously, this type of protective mask was desirable or available only to military personnel or workers in certain types of dangerous environments. However, the threat of terrorism has led to these masks becoming available on a more widespread scale to consumers in the general population.

The typical protective mask is available in a variety of sizes to fit adults and children. The mask is designed to fit snugly around the wearer's face to form a seal that prevents the wearer from being exposed to harmful airborne agents. The wearer breathes air through a filter that is attached to the mask. The filter, which typically contains activated charcoal, removes any dangerous biological and chemical agents from the air. Some masks are equipped with a voice box that allows to wearer to speak and communicate with others more easily while wearing the mask.

In a situation where a person is forced to wear one of these protective masks, it is not uncommon for the person to need to wear the mask for an extended period of time. During this extended period, the wearer is typically unable to remove the mask to drink water or any other beverage, as this would break the seal and expose the wearer to the dangerous airborne agents.

As a result, there have been proposed in the prior art various means for allowing the wearer of a protective mask to ingest liquids without removing the mask from his face. However, given that these protective masks were more often than not used in a military setting, the previously proposed solutions were typically military-oriented. For example, certain U.S. patents show a protective gas mask with a drinking tube attached to the mask. The drinking tube is attachable to a standard sized military canteen that holds water or some other liquid. The wearer can thus drink from the canteen through the tube without removing the mask.

However, these devices were not, so far as is known, adapted or suitable for use with other types of liquid containers besides canteens. If an individual, whether a ordinary citizen or military personnel, owned a protective mask, but did not own or have access to a canteen or other standard military liquid container, they would not be able to effectively utilize the drinking tube to drink liquids while wearing the mask. Regulation military canteens can be relatively expensive and are often difficult to locate and/or distribute. As a result, these prior art uses for the protective masks were severely limited.

### SUMMARY OF THE INVENTION

In light of the foregoing, the present invention relates to an apparatus and method for allowing the wearer of a protective mask to utilize the drinking tubing of a gas mask to drink liquids from standard commercial beverage containers without needing to remove the mask or break the seal between the mask and the wearer's face. The standard commercial beverage container, for example a commercial water bottle, does not need to meet military specifications, and is typically more economical, more readily available, and easier to distribute than a military canteen. An adaptor is provided that connects the drinking tubing of the protective mask with the opening of the commercially available beverage container. In one embodiment, the adaptor has a stem at one end that can be inserting into the tubing of the protective mask. In another embodiment, the adaptor is secured to the beverage container by threading. In another embodiment, the adaptor is constructed of a material that is resistant to chemical or biological agents. In another embodiment, the adaptor has a plurality of different sized sections so that the adaptor may be used on various sizes of beverage containers.

### BRIEF DESCRIPTION OF THE DRAWINGS

A better understanding of the present invention can be obtained when the detailed description set forth below is reviewed in conjunction with the accompanying drawings, in which:

FIG. 1 is a side view of a protective mask as used in accordance with the present invention.

FIG. 2 is a perspective view of an adaptor in accordance with the present invention.

FIG. 3 is a side view of an adaptor in accordance with the present invention.

FIG. 4 is a side view of a protective mask being used with an adaptor in accordance with an embodiment of the present invention.

FIG. 5 is a side view of an alternative embodiment of the present invention.

FIG. 6 is a side view of an alternative embodiment of the present invention.

FIG. 7 is a side view of an alternative embodiment of the present invention.

FIG. 8 is a side view of an alternative embodiment of the present invention.

FIG. 9 is a side view of an alternative embodiment of the present invention.

### DETAILED DESCRIPTION OF EXEMPLARY EMBODIMENTS

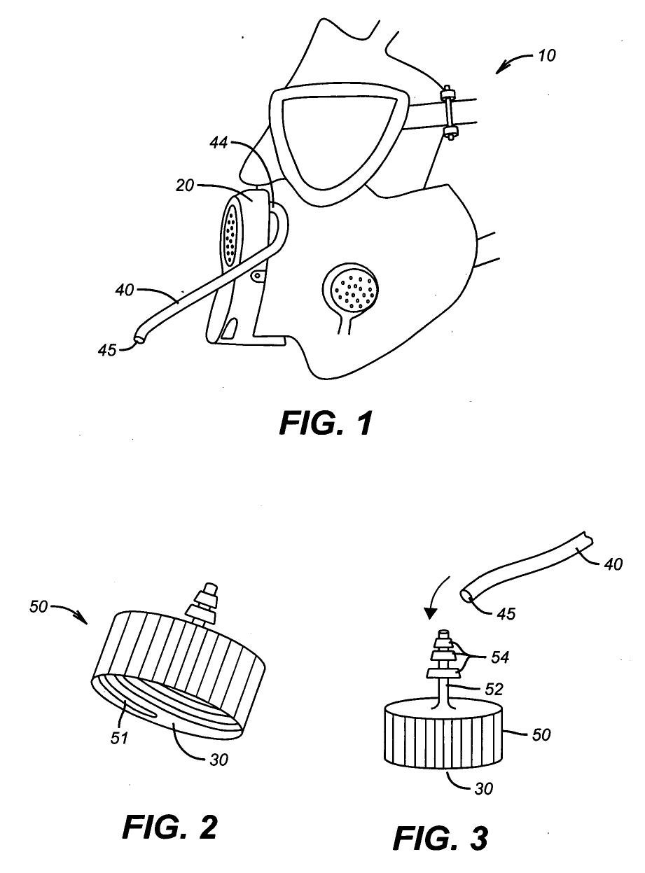

FIG. 1 shows a protective mask 10. Typically, the mask 10 includes a front section 20 that is located near the wearer's mouth. A first end 44 of a length of hollow outer tubing 40 is mounted to the front section 20 of the mask 10 or to any other region of the mask 10 that is near the wearer's mouth. In one embodiment, the first end 44 may extend through the mask 10 and provide liquid to the wearer's mouth either directly or else with the aid of a suitable mouthpiece. Note, however, that any tubing design that allows liquid from the outer tubing 40 to reach the wearer's mouth without the wearer needing to remove the mask 10 would be in accordance with the present invention. Preferably, the outer tubing 40 is constructed of a material of suitable resistance to chemical or biological agents, for example polypropylene, polyurethane, metals or other similar materials. However, this is not required. A second end 45 is attached to a source of water or other liquid may pass through the tubing 40 and the wearer can drink without needing to remove the mask 10.

FIG. 2 shows an embodiment of an adaptor 50 in accordance with the present invention. Preferably, the adaptor 50 is constructed of a material of suitable resistance to chemical or biological agents, for example polypropylene, polyurethane, metals or other similar materials. However, this is not required. In the embodiment shown in FIG. 2, the adaptor 50 has a hollow interior chamber 30. Threading 51 is located along the walls of the hollow interior chamber 30. The adaptor 50 is generally the same size, shape, and configuration as a cap typically used on a conventional, commercially available water bottle. The threading 51 along the walls of the hollow interior 30 of the adaptor 50 is sized and configured so that it mates with the threading on the neck of the commercially available water bottle. Thus, the adaptor 50 can be twisted to fit securely unto such water bottle.

In an embodiment of the present invention as shown in FIG. 3, an elongated stem 52 extends from the top of the adaptor 50. The stem 52 has a hollow interior so that water or other liquid may pass through the stem 52. The stem 52 has an outer diameter that is smaller than the inner diameter of the outer tubing 40. Thus, the stem 52 can be fitted into the outer tubing 40 so that water or other liquid can pass through the hollow interior 30 of the adaptor 50 and through the stem 52 into the tubing 40. At least one raised ridge 54 is provided on the outer surface of the stem 52. The ridge(s) 54 can be constructed of a resilient, gripping material such as rubber. When the stem 52 is inserted into the tubing 40, the ridge(s) 54 grip the interior surface of the tubing 40 so that the stem 52 cannot be easily pulled out from the tubing 40. Also, the ridge(s) 54 aid in creating a hermetic or airtight seal so that biological or chemical agents from the atmosphere cannot contaminate the liquid in the tubing 40. Alternatively, other designs can be used to prevent the stem 52 from being pulled out from the tubing 40 and/or to prevent contamination of the liquid in the tubing 40.

In an alternative embodiment, the end 45 of the tubing 40 will have a closed-off tip to prevent contaminants from entering the tubing 40 when the adaptor 50 is not attached. When the stem 52 is inserted into the tubing end 45, the tip is opened to allow the stem 52 to enter. Alternatively, an elongated stem can be located at the end 45 of the tubing 40, and an opening can exist on the adaptor 50 to produce a similar result.

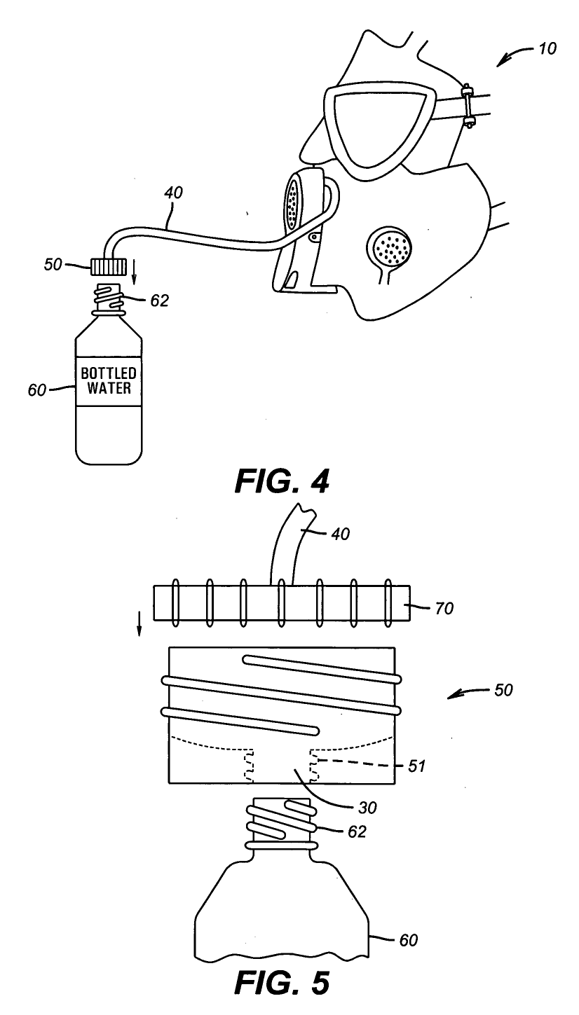

As shown in FIG. 4, the outer tubing 40 is fitted upon the stem (not shown) of the adaptor 50 and the adaptor 50 is affixed to the neck 62 of a standard water bottle or similar beverage container 60. The wearer of the mask 10 can thus drink liquid from the bottle 60 through the tubing 40 without removing the mask 10.

FIG. 5 shows an alternative embodiment of the present invention in which the adaptor 50 can be utilized to connect the outer tubing 40 of the mask 10 to a commercial bottled liquid source 60 in the case where the tubing 40 has an attached canteen cap 70. The adaptor 50 is attached to the canteen cap 70 by, for example, threading. The adaptor 50 effectively serves as a “reducer” for the canteen cap 70 so that the cap 70 can be made to securely fit onto the neck 62 of the bottled liquid source 60. The adaptor 50 has a hollow interior section 30 with threading 51 that is sized to allow for a secure fit between the adaptor 50 and the neck 62 of the bottled liquid source 60.

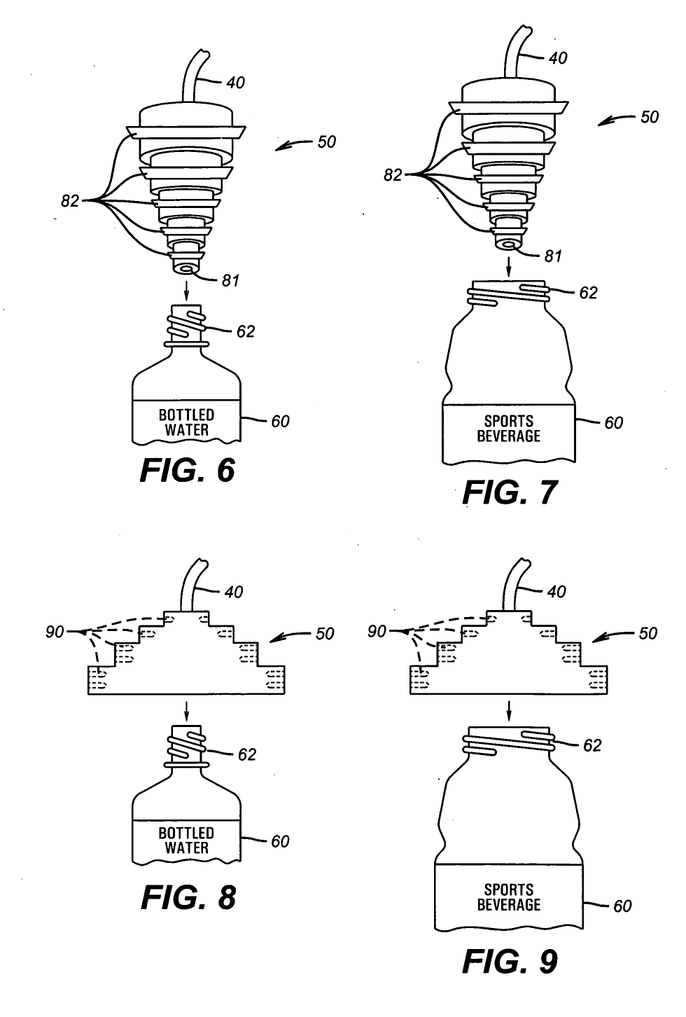

FIGS. 6 & 7 show an alternative embodiment of the present invention in which the adaptor 50 can be used with various sized commercial beverage containers 60. In this embodiment, the adaptor 50 is inserted into the neck or nozzle 62 of the beverage container. The adaptor 50 has a plurality of sections, with each section having a different outer diameter. The outer diameter measurement for each of the different adaptor 50 sections should match the sizes of commonly occurring neck or nozzle sizes for commercial beverage containers. Each section has a gripping element 82 constructed of, for example, rubber, that will grip the interior of the neck or nozzle 62 of the beverage container 60 so that the adaptor 50 cannot be easily removed from the beverage container 60, to prevent spilling of the liquid, and to prevent contaminants from reaching the liquid. In the embodiment shown, the wider the neck or nozzle 62 of the beverage container 60, the further that the adaptor 50 must be inserted into the beverage container 50 in order for the proper sized adaptor 50 section and gripping element 82 to securely grip the interior of the neck or nozzle 62 of the container 60. The adaptor 50 has an opening 81 so that liquid from the beverage container 60 can enter the adaptor 50 and be delivered to the mask wearer.

FIGS. 8 & 9 show another alternative embodiment of the present invention in which the adaptor 50 can be used with various sized commercial beverage containers 60. In this embodiment, the adaptor 50 has a hollow interior and a plurality of sections each having differing inner diameters. The inner diameter measurements for each of the different sections of the adaptor 50 should match the sizes of commonly occurring neck or nozzle sizes for commercial beverage containers. Each section of the adaptor 50 has threading in its interior walls that matingly corresponds to the threading on the exterior of the neck or nozzle 62 of the different sized beverage containers 60, so that the neck or nozzle 62 of the beverage container 60 is inserted into the hollow interior section of the adaptor 50 and attached to the section of the adaptor 50 with correspondingly sized threads. In the embodiment shown, the narrower the neck or nozzle 62 of the beverage container 60, the further that the neck or nozzle 62 of the beverage container 60 must be inserted into the adaptor 50 in order for the proper sized adaptor 50 section to securely grip the exterior of the neck or nozzle 62 of the container 60.

It can thus be seen that the adaptor 50 of the present invention allows the wearer of a protective mask 10 to drink liquid from a commercially available liquid source 60 without removing the mask 10. The adaptor 50 can be sized to fit the necks or nozzles 62 of the containers of various brands of U.S. or foreign produced commercial beverages. for example, Ozarka®, Poland Springs® or Dasani® brands of bottled water, Coca-Cola® or Pepsi®, soda, Gatorade® sports drink or other similar beverages. It is not necessary that the bottled beverage container be constructed of a material that meets military specifications or any certain standards for resistance against certain chemical or biological agents such as those required for military issued canteens, for example, those standards set by the National Institute for Occupational Safety & Health (“NIOSH”). However. in a preferred embodiment of the present invention, the adaptor would be constructed of a material that would provide adequate resistance to chemical or biological agents.

The foregoing disclosure and description of the invention are illustrative and exemplary thereof, and various changes in the size, shape and materials, as well as in the details of the illustrated construction, may be made without departing from the spirit of the invention.

1. An adaptor for allowing a wearer of a protective mask to drink liquid from a commercially available bottled liquid source without removing the mask, comprising:
a commercially available bottled liquid source;
a drinking tube, the tube attachably fitted to the protective mask; and
an adaptor connecting the drinking tube to the bottled liquid source, the adaptor comprising a securing element that is sized to allow the adaptor to securely fit onto the commercially available bottled liquid source.

2. The apparatus of claim 1, wherein the securing element is threading.

3. The apparatus of claim 1, wherein the adaptor is constructed of a material that is resistant to biological or chemical agents.

4. A method for allowing a wearer of a protective mask to drink liquid from a commercially available bottled liquid source without removing the mask, comprising:
supplying a drinking tube, the drinking tube being attachably fitted to the protective mask;
supplying a commercially available bottled liquid source;
connecting the drinking tube to the bottled liquid source via an adaptor, the adaptor comprising a securing element that is sized to allow the adaptor to securely fit onto the commercially available bottled liquid source.
